(19) United States
(12) Patent Application Publication
(10) Pub. No.: US 2002/0042282 A1
(43) Pub. Date: Apr. 11, 2002

(54) System for controlling mobile transmitting and/or receiving devices wirelessly connected to a central unit

(76) Inventor: Axel Haupt, Langenhagen (DE)

Correspondence Address: REED SMITH, LLP, 375 Park Avenue, New York, NY, 10152, US

(21) Appl. No.: 09/908,344

(22) Filed: Jul. 18, 2001

(30) Foreign Application Priority Data
Jul. 22, 2000 (DE) 100 35 824.1

(51) Int. Cl. H04B 7/00

(52) U.S. Cl. 455/509; 455/517

(57) ABSTRACT

A system for the control of mobile transmitting and/or receiving devices connected to a central unit, wherein the transmitting and/or receiving devices are adapted to transmit and/or receive data and/or signals in a first frequency range. In order in such a system to easily permit central control of mobile transmitting and/or receiving devices which are in a limited environment from the central unit, it is provided in accordance with the invention that the transmitting and/or receiving devices and the central unit have means for bidirectional communication in a second frequency range for control of the transmitting and/or receiving devices. The invention which can preferably be used in a limited environment such as a stage, a film studio, a music studio or a theater for the control of mobile apparatuses such as microphones, loudspeakers or cameras, also concerns a corresponding transmitting and/or receiving device, a corresponding central and sub-unit and a corresponding control method.

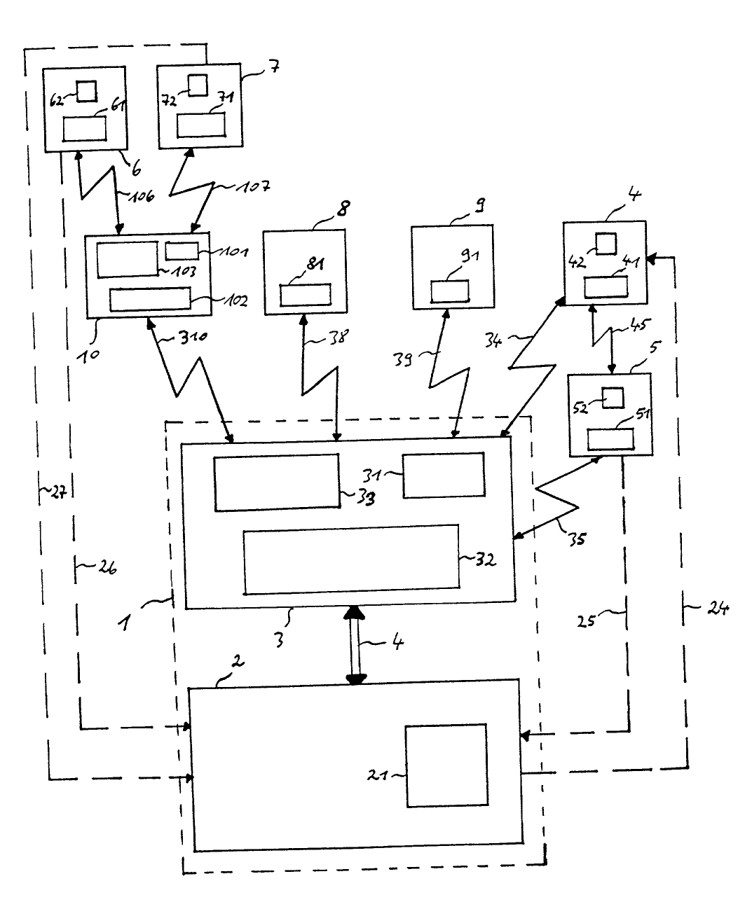

### CROSS REFERENCE TO RELATED APPLICATIONS

This application claims priority of German Application No. 100 35 824.1 filed Jul. 22, 2000, the complete disclosure of which is hereby incorporated by reference.

### BACKGROUND OF THE INVENTION

a) Field of the Invention

The invention concerns a system for controlling mobile transmitting and/or receiving devices wirelessly connected to a central unit, wherein the transmitting and/or receiving devices are adapted to transmit and/or receive data and/or signals in a first frequency range. The invention also concerns a corresponding transmitting and/or receiving device, a corresponding central unit, and a corresponding method of controlling mobile transmitting and/or receiving devices wirelessly connected to a central unit.

b) Description of the Related Art

In relation to wireless microphone and monitor installations, it is known for the stationary components to be equipped with wire-connected computer interfaces. In that way it is possible for the operating parameters of those components to be interrogated and set by way of the computer. Incorporation into the digital infrastructure of studios, theaters and stages is possible in that way. In that respect, rapid re-configuration for rehearsals and alternative activities are not any problem but are particularly supported and in many installations are even first made a viable possibility.

Hitherto however it was not possible for the mobile part of those installations, more specifically for example transmitters in the case of wireless microphones and receivers in the case of wireless monitor installations, to be also incorporated into that linkage arrangement. Admittedly, the internal prerequisites of control by means of microprocessors are present, and the operating parameters are also present in a suitable form and can be appropriately set. There is however not a suitable communication path between the mobile apparatus and an external computer. That communication path must be wireless as the apparatuses must also be addressed in use while they are being worn by actors. Hitherto it has only been transmission of the useful signal that is effected by way of a useful signal radio path.

One approach to resolving such problems arises in relation to systems which require central synchronization in order to ensure trouble-free co-operation of many transmitters in a multi-channel mode: synchronization is implemented by way of a central stationary transmitter by way of which control commands can also be broadcast. In that case the mobile transmitters require an additional synchronization receiver. The operating radio path can be used as the return channel from the mobile transmitter to the external computer, by a procedure whereby additional information is also modulated thereon.

That approach however suffers from a number of disadvantages, in particular in relation to conventional analog radio paths: firstly, synchronization of those systems is not required as all mobile transmitters operate on another frequency, for example in the UHF-range. Setting up a synchronization frequency makes frequency management more difficult and, by virtue of the close proximity of the operating radio frequency and the control radio frequency, gives rise to problems in the mobile transmitter. Either a complete parallel receiver has to be additionally installed for example for the UHF-range or the transmitter changes at times into the reception mode, in which case then nonetheless the frequency still possibly has to be changed. Apart from difficulties in respect of technical implementation, the audio signal to be transmitted and other operating parameters of the mobile transmitter are adversely influenced. The same applies in principle in regard to digital audio transmission systems if each mobile transmitter operates on a different frequency.

### OBJECT AND SUMMARY OF THE INVENTION

The primary object of the present invention is so to design the system set forth in the opening part of this specification, in a simple and inexpensive manner, that the mobile devices, that is to say the mobile transmitting and/or receiving devices, can be centrally controlled from the central unit wirelessly and with simple means. The invention further aims to provide corresponding transmitting and/or receiving devices, a corresponding central unit and a corresponding control method.

In accordance with the invention, based on the system as set forth in the opening part of this specification, that object is attained in that the transmitting and/or receiving devices and the central unit have means for bidirectional communication in a second frequency range for control of the transmitting and/or receiving device.

The basic concept in this respect is equipping the mobile apparatuses with an additional bidirectional wireless communication path for the transmission of control signals, which is independent of the, useful signal radio path, and thus preparing the way for linking those components to a higher-order infrastructure, for example the control computer of the central unit. In that way new functionalities can be opened up for the mobile apparatuses and the entire system. This general approach means that the mobile apparatuses can additionally be equipped for example with a transceiver module for transmitting and/or receiving modes, for the transmission of control signals. In that respect the frequency of the communication path should be as far as possible from the frequency of the operating radio path over which the actual useful data are transmitted in order to avoid mutual interference.

In regard to the choice of the bidirectional communication means, in particular the following, demands on the communication path should also be taken into consideration:

independence of the operating radio path,

extremely low amount of energy required and an extremely small amount of space required in the mobile apparatus,

selective addressing of the mobile apparatuses,

very good error protection in regard to falsification of transmitted and received data, and

very inexpensive implementation.

A suitable example for the bidirectional communication means are transceiver modules, for example so-called ‘Bluetooth’ modules, from the area of mobile communications or electronic identification tags from the area of the merchandise economy. Both variants can satisfactorily meet the above-indicated requirements. This can be shown by reference to the example of the ‘Bluetooth’ modules:

The modules represent a completely integrated one-chip solution for bidirectional data transmission, which have been developed with an aim to operating with a very low level of energy consumption. The amount of space required is very small.

Polished authentification algorithms ensure that only transmitters and receivers which are intended to communicate with each other do in fact communicate with each other.

The transmission of data is basically bidirectional.

Besides the error protection mechanisms which are anchored in the standard, further mechanisms can be accommodated in the data stream.

Due to a range with a radius of about 10 meters, in a particular configuration also being 100 meters, there is no need to directly approach the mobile apparatus to be controlled.

There is no effect in the useful signal frequency range (UHF) as operation is in a completely different frequency range (2.4 GHz).

In substance the ranges of 450-980 MHz (UHF-band), 1.785-1.8 GHz and 2.4-2.48 MHz (ISM-band) are available for the useful frequency range. For the transmission of items of control information it is possible to use for example the frequency ranges of 0.1-5 MHz (inductive), 433-434.7 MHz (ISM-band), 865-868 MHz and 2.4-2.48 MHz (ISM-band). From the point of view that the useful frequency range and the control frequency range should be as far apart as possible, there are thus sufficient combination options to operate a system according to the invention. An example of a useful/control frequency range combination would be for instance 480-980 MHz/2.4-2.48 GHz or 2.4-2.48 GHz/433-434.7 MHz.

Advantageous configurations and developments of the system according to the invention are set forth in the appendant claims. The transmitting and/or receiving devices are preferably used in mobile apparatuses with which audio and/or video data are transmitted and/or received, such as for example in microphones, loudspeakers, monitor installations or cameras. The invention is preferably suited for use in a restricted environment, when therefore mobile apparatuses are to be centrally controlled in a limited environment by the central unit, such as for example on a theater/music stage, a television studio, a music production studio or a film production location or at the location of an event or function.

The invention also concerns a transmitting and/or receiving device, a unit and a method, which can be of the design configuration and involve the developments in the same or corresponding manner to the system according to the invention discussed above.

### BRIEF DESCRIPTION OF THE DRAWING

The invention is described in greater detail hereinafter with reference to the FIGURE showing a block circuit diagram of a system according to the invention.

### DESCRIPTION OF THE PREFERRED EMBODIMENTS

The central unit 1 has a central stationary control and processing unit 2 and a control and communication unit 3 which are connected together by way of a line 4. Disposed in a limited environment from the central unit 1 are a plurality of mobile apparatuses 4 through 9 which are in the form of transmitting and/or receiving devices and which in part transmit data and/or signals to the central unit 1 (apparatuses 5, 6, 7) and receive data and/or signals from the central unit 1 (apparatus 4) and which are directly or indirectly controlled by the central unit 1. Shown here by way of example as the mobile apparatuses are the following: a monitor installation 4 which can be arranged for example in the ear (for example a small loudspeaker), a microphone 5, a further microphone 6, a video camera 7, a stage element 8 and a light installation 9.

The stationary control device 2 has a transmitting and receiving module 21 with which data and/or signals (useful signals) can be sent by way of a radio path to individual mobile apparatuses and/or received from individual mobile apparatuses. For that purpose the mobile apparatuses have suitable transmitting and/or receiving modules: the monitor installation 4 has a receiving module 42, and the microphones 5, 6 and the video camera 7 have receiving modules 52, 62, 72. Those transmitting and/or receiving modules are wirelessly connected by way of the radio connections 24, 25, 26, 27 to the transmitting/receiving module 21 of the control unit 2 so that useful data or signals can be transmitted by way of those connections in a first frequency range. The frequency range used for the transmission and the nature of the data transmission—digital or analog—are not essential for the invention.

So that the mobile apparatuses 4 through 9 can be centrally controlled by the central unit 1, both the control unit 3 and also the mobile apparatuses 4 through 9 each have a respective control module 31, 41, 51, 61, 71, 81, 91 equipped with transmitting and/or receiving functionality, for direct or indirect bidirectional communication with each other. For that purpose, between the mobile apparatuses 4, 5, 8, 9 and the control unit 3 there are bidirectional communication paths 34, 35, 38, 39 by way of which in particular control commands can be transmitted to the mobile apparatuses 4, 5, 8, 9 and operating parameters can be transmitted to the control unit 3. So that current operating parameters can also be displayed and altered, the control unit 3 also has in particular an operating unit 32 and a display unit 33.

For control of the mobile apparatuses 6, 7, it is also possible to provide a mobile control unit 10 which serves as a sub-unit of the central unit 1 and which is equipped substantially like the stationary control unit 3, namely it has a control module 101, an operating unit 102 and a display unit 103. There is a bidirectional communication connection 310 between the preferably stationary control unit 3 and the mobile control unit 10 while between the mobile control unit 10 and the mobile apparatuses 6, 7 there are bidirectional communication connections 106, 107 so that the mobile apparatuses 6, 7 are controlled indirectly by the control unit 3 by way of the mobile control unit 10. Control however can also be effected entirely from the mobile control unit 10 which then respectively passes the current operating parameters and settings to the stationary control unit 3 by way of the communication path 310.

Control by way of the bidirectional communication paths is effected in a second frequency range which is preferably markedly different from the first frequency range by way of which useful signal transmission is effected between the central unit and individual mobile apparatuses. It is also possible to provide that there is a separate communication frequency for individual ones or for each mobile apparatus or that suitable authentification algorithms ensure that only those apparatuses communicate with each other, in respect of which that is also wanted.

Both the control unit 3 and also the control unit 10 can be mobile, for example in the form of a laptop, PDA or palmtop-PC.

Some further advantageous aspects of the invention are set forth hereinafter by way of example in relation to wireless microphone or in-the-ear monitor installations.

The mobile apparatuses can be constructed entirely without operating elements. It is even possible to forego an on/off switch if the apparatus has a standby mode in which it has a negligible power consumption. If the operating elements are omitted, there is also no longer any need for apertures through the casing so that the apparatus can be designed in such a way as to afford sealing integrity in relation to moisture, perspiration and dust.

All operating parameters of the mobile apparatuses can be interrogated, displayed and set by way of the control unit. They can be for example as follows: operating states, operating frequencies, microphone sensitivity, various internal level and switching states, battery condition, choice of compandor systems, model and manufacturing data or diagnostic data. By means of suitable software those data can be displayed for all apparatuses in the radio region and if required can be altered manually or automatically. Coupling of the control unit to the associated stationary apparatuses such as receivers or transmitters (processing unit 2) permits automatic pairing of the apparatuses in respect of their operating parameters. If the control unit is coupled to the computer infrastructure present in studios, theaters and so forth, higher order management, selection and control of the operating parameters of the wireless transmission paths is thus possible. All planning and configuring of the transmission paths can be effected without the actual apparatuses. After installation has been effected all necessary data for the production which is currently to be implemented are loaded into the respective apparatuses.

In particular portable, small mobile control units which are used as sub-units open up a wide field. On the one hand they can be used as a simple operating apparatus, in which case then the operator only needs to approach the mobile apparatus to within a few meters in order to afford the communication. A convenient operator interface, as could not be embodied in the actual apparatus simply by virtue of the size of the display, serves for visualization and manipulation of parameters. On the other hand however they can also take over complete management of an installation in a semi-automatic or fully automatic procedure. This affords a solution to the problems of ever progressively smaller displays and operating systems of the apparatuses by virtue of progressive miniaturization.

Detached sub-units 10, when stationarily mounted at a suitable location, can serve for the automatic display of the operating parameters as soon as a mobile transmitter or receiver approaches the station. When the mobile apparatuses are disposed in the radio region of the sub-unit, in that way a continuous overview of the operating parameters is possible on the display of the sub-unit, or the operating parameters are found out when walking past.

The rigid frequency allocations to the apparatuses can also be eliminated. The mobile transmitters or receivers no longer require an internal permanent memory for the operating parameters. Immediately prior to use they are programmed for the operating parameters which are currently required. In that way it is possible for handling of the operating frequencies to be made more flexible. On the one hand, complete production requires only as many frequencies as wireless paths are in operation at the same time, while on the other hand it is possible to switch over to a substitute frequency manually or automatically if the intended frequency has a problem.

By virtue of constructing so-called ‘radio locks’ which serve as an entry lock device and through which an actor must pass when he goes on stage or returns therefrom, it is possible for the mobile apparatuses to be switched specifically into the active or standby mode. On the one hand, the actor cannot in that way inadvertently go on stage with the apparatus switched off or incorrectly set as all parameters are checked and possibly corrected in the radio lock. On the other hand, the mobile apparatuses are switched off when leaving the stage in order to save on battery power and to give the actor the possibility of moving freely and easily behind the stage.

As the control modules permit a bidirectional communication mode of operation, the mobile apparatuses can also communicate with each other, as is provided in the FIGURE between the apparatuses 4 and 5 with the communication path 45. Thus it is possible for the apparatuses to organise themselves automatically, for example in regard to the operating frequencies, and in that respect to take account of the capabilities of the individual apparatuses. Mobile installations, in particular with a few transmission paths, can thus be set in operation quickly and easily.

The communication paths provided in accordance with the invention can be highly advantageous in the case of a software update of apparatuses in regard to the customer. In the simplest case the new software is loaded into the mobile apparatuses from a storage medium of the control unit. The control unit acquires the corresponding data files for example by way of a floppy disk or the Internet from the manufacturer. A further way is controlling and implementing that procedure directly from the manufacturer by remote control of the control unit directly on site at the customer. In that way the manufacturer is in a position to clearly identify by means of manufacturing codes the apparatuses in regard to which an update has been executed.

In that way the apparatuses also gain in flexibility in terms of software. The wish to develop the mobile apparatuses to be as small and power-saving as possible constitutes a compulsion to be economical with the amount of the program memory. Therefore, particularly in the case of future fully digitized apparatuses, it will not be possible or expedient for various complex signal-influencing algorithms to be held in the apparatus. With a comfortable and convenient programming interface, the apparatus can be provided with the desired software at the customer depending on the respective situation of use involved. It is even possible in the event of problems for software which has been especially modified by the manufacturer to be brought into use on site immediately at the location of the customer.

A similar form of wireless control and configuring as in the described sector of studios, theaters and stage productions can also be envisaged for further apparatuses which are used there. Thus for example lighting arrangements can be incorporated in that form into a higher-order wireless control system, and likewise actuators for stage sets and scenery. Other uses of the invention for controlling mobile apparatuses in a limited environment can also be envisaged. That is shown in the figure by means of the example of a stage element 8 and a light installation 9 which are each equipped with a respective control module 81, 91 and which can thus be controlled centrally by the control unit 3 by way of the communication paths 38, 39.

While the foregoing description and drawings represent the present invention, it will be obvious to those skilled in the art that various changes may be made therein without departing from the true spirit and scope of the present invention.

What is claimed is:

1. A system for controlling mobile transmitting and/or receiving devices wirelessly connected to a central unit, comprising that:
said transmitting and/or receiving devices are adapted to transmit and/or receive data and/or signals in a first frequency range; and
said transmitting and/or receiving devices and said central unit have means for bidirectional communication in a second frequency range for control of the transmitting and/or receiving devices.

2. The system as set forth in claim 1 wherein said first and second frequency ranges do not overlap.

3. The system as set forth in claim 1 wherein said transmitting and/or receiving devices and the central unit are adapted to transmit and/or receive audio and/or video data in the first frequency range.

4. The system as set forth in claim 3 wherein said transmitting and/or receiving devices are adapted to transmit and/or receive data in the form of mobile apparatuses, in particular a microphone, loudspeaker, audio and/or video monitoring device and/or a camera.

5. The system as set forth in claim 1 wherein said central unit is adapted for complete control and operation of transmitting and/or receiving devices.

6. The system as set forth in claim 1 wherein said central unit is adapted for setting the operating parameters of individual ones of or all transmitting and/or receiving devices.

7. The system as set forth in claim I wherein said central unit is adapted to display the current setting of operating parameters of individual ones of or all transmitting and/or receiving devices.

8. The system as set forth in claim 1 wherein there is provided at least one mobile sub-unit wirelessly connected to the central unit for the control of individual transmitting and/or receiving devices.

9. The system as set forth in claim 1 wherein there is provided at least one autarkical sub-unit for the control of individual transmitting and receiving devices, which entirely or partially simulates the functionalities of the central unit.

10. The system as set forth in claim 1 wherein for an individual or each transmitting and/or receiving device in the second frequency range there is provided a separate frequency for bidirectional communication with the central unit.

11. The system as set forth in claim 1 wherein said central unit is adapted for programming of the transmitting and/or receiving devices with the required operating parameters immediately prior to use thereof.

12. The system as set forth in claim 1 wherein said transmitting and/or receiving devices are adapted for communication with each other.

13. The system as set forth in claim 1 wherein said central unit or an optionally provided sub-unit and the transmitting and/or receiving devices have a programming interface for loading new software into the transmitting and/or receiving devices by way of the bidirectional communication path in the second frequency range.

14. The system as set forth in claim 1 wherein said system is used for control of transmitting and/or receiving devices in a limited environment, in particular in a studio, a theater or a stage area.

15. The system as set forth in claim 14 wherein said limited environment has an entry lock for the transmitting and/or receiving devices for checking and/or setting the operating parameters of the transmitting and/or receiving devices when being brought into or taken out of the limited environment.

16. The system as set forth in claim 14 wherein said further elements in the limited environment, in particular lighting arrangements or stage elements, have means for bidirectional communication in the second frequency range for control by the central unit.

17. A transmitting and/or receiving device for transmitting and/or receiving data and/or signals to a central unit by way of a radio path in a first frequency range, comprising means for bidirectional communication in a second frequency range for control of the transmitting and/or receiving devices by the central unit.

18. The transmitting and/or receiving device as set forth in claim 17 wherein said transmitting and/or receiving device is adapted for transmitting and/or receiving audio and/or video data and is in the form of a mobile apparatus, in particular a microphone, loudspeaker, monitoring device or camera.

19. A unit, in particular a central unit or a sub-unit, for a system as set forth claim 1, comprising means for wireless connection to transmitting and/or receiving devices for transmitting and/or receiving data and/or signals in a first frequency range, and further comprising means for bidirectional communication in a second frequency range for control of the transmitting and/or receiving devices.

20. The unit as set forth in claim 19 wherein said bidirectional communication means are arranged in a mobile unit, in particular a laptop, a PDA or a palmtop computer.

21. A method of controlling mobile transmitting and/or receiving devices wirelessly connected to a central unit, comprising:
arranging that said transmitting and/or receiving devices are adapted to transmit and/or receive data and/or signals in a first frequency range; and
effecting control of the transmitting and/or receiving devices by way of a bidirectional communication path in a second frequency range between transmitting and/or receiving devices and the central unit.
